(19) United States
(12) Patent Application Publication
(10) Pub. No.: US 2008/0160183 A1
(43) Pub. Date: Jul. 3, 2008

(54) CONDUCTIVE SINTERED LAYER FORMING COMPOSITION AND CONDUCTIVE COATING FILM FORMING METHOD AND BONDING METHOD USING THE SAME

(76) Inventors: Eiichi Ide, Hitachi (JP); Toshiaki Morita, Hitachi (JP); Yusuke Yasuda, Hitachi (JP); Hiroshi Hozoji, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/965,810

(22) Filed: Dec. 28, 2007

(30) Foreign Application Priority Data
Dec. 28, 2006 (JP) 2006-353652

(51) Int. Cl. H01B 1/08; B05D 5/12; B22F 7/04

(52) U.S. Cl. 427/126.5; 252/500; 419/9; 419/8

(57) ABSTRACT

There is provided a conductive sintered layer forming composition and a conductive sintered layer forming method that can lower heating temperature and shorten heating time for a process of accelerating sintering or bonding by sintering of metal nano-particles coated with an organic substance. The conductive sintered layer forming composition may be obtained by utilizing a phenomenon that particles may be sintered at low temperature by mixing silver oxide with metal particles coated with the organic substance and having a grain size of 1 nm to 5 μm as compared to sintering each simple substance. The conductive sintered layer forming composition of the invention is characterized in that it contains the metal particles whose surface is coated with the organic substance and whose grain size is 1 nm to 5 μm and the silver oxide particles.

### BACKGROUND OF THE INVENTION

1. Field of the Invention

The present invention to a conductive sintered layer forming composition applicable for use in bonding in packaging electronic parts and semiconductors to a circuit board or a lead frame or in forming a conductive film such as wires and electrodes and a conductive coating film forming method using the same.

2. Related Art

It has been known that when a grain size of a metal particle decreases to nano-size and a number of structuring atoms decreases, a ratio of a surface area to a volume of the particle increases sharply and melting point and sintering temperature drop remarkably as compared to a bulk state (particles whose grain size is 1 to 1000 nm will be defined as a nano-particle in the present specification). Then, it has been reported to apply the nano-particle as a component or a bonding material in forming a conductive coating film or wires by utilizing the low temperature sintering function of the nano-particle. However, activity of the surface increases remarkably when the grain size of the metal particle decreases, so that it is essential to coat the surface of the particle with an organic substance for handling to prevent coagulation. Therefore, various technologies for coating the surface of the nano-particle with the organic substance are being studied.

Processes of removing the organic substance by heating and of promoting the sintering phenomenon among metal particles become essential as a technology common in a process of forming a conductive coating film and wires on a printed circuit board or of bonding electronic parts and semiconductors by using the conductive sintered layer forming composition whose main material is metal nano-particles coated with the organic substance.

However, because it is necessary to reduce thermal damage (e.g., when applied to organic substrate whose heat resistance is low) and thermal deformation such as warp of peripheral members in the process described above, it is required to lower heating temperature. Furthermore, while there is a case of giving a pressurization process in addition to the heating process when it is used as a bonding material, the pressure is also required to be lowered in order to avoid physical damages of the electronic parts and semiconductors.

As for the lowering of temperature for the bonding method using the nano-particle, Journal of Japan Institute of Electronics Packaging (Non patent Literature 1) November 2006, Vol. 9 No. 7 has reported a phenomenon that decomposition of the organic substance coating the nano-particle is accelerated and the bonding strength is enhanced by combining silver carbonate as for the complex particle of the nano-particle coated with the silver carbonate and organic substance.

It is then necessary to realize the lowering of the heating temperature, or lowering of pressure in case of pressurizing, in removing the organic substance in the process of bonding the electronic parts or forming the conductive coating film on the substrate by using the composition whose main material is metal nano-particle coated with the organic substance.

As described above, the phenomenon that the decomposition of the organic substance is accelerated by combining the silver carbonate in the complex particle of nano-particle coated with the silver carbonate and organic substance has been disclosed. However, there have been problems that a large amount of CO₂ gas generates when the silver carbonate is decomposed to silver, that a large contraction of volume of 45.3 vol. % of volume change from the silver carbonate to metal silver occurs and that it causes a large number of voids in a junction layer. Still more, no detailed explanation has been given about an interaction and mixed ratio of the silver carbonate and the organic substance.

In view of these problems, the present invention provides a conductive sintered layer forming composition and a conductive sintered layer forming method that allow lowering of heating temperature and shortening of heating time to be achieved in a process of accelerating sintering by heating to metal nano-particle coated with an organic substance.

Still more, the present invention provides the conductive sintered layer forming composition and the method that allow lowering of heating temperature, shortening of heating time and reduction of pressurizing force in bonding, to be achieved in a process of accelerating bonding by heating and pressurizing by use of the metal nano-particle coated with the organic substance.

### SUMMARY OF THE INVENTION

The abovementioned problem may be solved by using a conductive sintered layer forming composition containing metal particles whose surface is coated with an organic substance and whose grain size is 1 nm to 5 μm and silver oxide particles. The inventor et al. have found that silver oxide particle is reduced and metal silver whose grain size is 100 nm or less, i.e., silver nano-particle, can be fabricated by heating at temperature of 100° C. or more, that is lower than the case of heating and decomposing the simple substance of silver oxide only, by adding an adequate amount of a certain type of organic substance to the silver oxide particles. Still more, as the inventors proceeded experiment ardently, the inventors have found that the organic substance coating the nano-particle also has a similar effect and that silver oxide may be reduced at temperature lower than temperature in reducing the simple substance of the silver oxide and the silver oxide changes into silver nano-particle at this time, by mixing the organic substance with the silver oxide and heating them. It becomes possible to decompose the organic substance coating the nano-particle at temperature lower than the case of adding no silver oxide by utilizing this phenomenon. Still more, a minute conductive sintered layer may be formed by sintering reaction of both the metal nano-particle from which the organic substance has been removed and the silver nano-particle generated from the silver oxide by heating to temperature inducing a reaction of the both. That is, because the heating temperature that induces the reaction is lower than the heating temperature for decomposing the organic substance coating the nano-particle, the temperature for heating the simple substances of the both to form a sintered body may be remarkably lowered.

### EFFECT OF THE INVENTION

Thus, the invention can provide the conductive sintered layer forming composition and the conductive sintered layer forming method that allow the lowering of heating temperature and shortening of the heating time to be achieved in the process of accelerating the sintering by heating the metal nano-particle coated with the organic substance.

### BRIEF DESCRIPTION OF THE DRAWINGS

FIG. 1 is a graph showing a result of thermal analysis implemented for a composition in which silver particles coated with carboxylic acid, and silver oxide or silver carbonate are mixed by weight ratio of 1 to 1;

FIG. 2 is a graph showing a temperature-lowering rate of process completion temperature compared with a case when simple substance of metal particle coated with organic substance is used;

FIGS. 3A and 3B show a bonding method using a conductive sintered layer forming composition composed of both metal particles coated with the organic substance and silver oxide according to the invention;

FIG. 4 is a graph showing a result of shearing test for silver joint when the type of the organic substance and the mixed ratio of the silver oxide are changed with respect to the conductive sintered layer forming composition composed of both the metal particles coated with the organic substance and the silver oxide according to the invention;

FIG. 5 is a graph showing a relationship between bonding temperature and shear strength when a bonding material in which the silver oxide or silver carbonate particles are mixed with the metal particles coated with the organic substance;

FIG. 6 is a graph showing the relationship between bonding pressurizing force and the shear strength using a bonding material in which silver oxide or silver carbonate particles are mixed with the metal particles coated with the organic substance;

FIGS. 7A and 7B show a structure of a non-insulation type semiconductor device that is one of the embodiments of the invention;

FIG. 8 is a perspective view showing a sub-assembly section of an insulation type semiconductor device of the invention;

FIG. 9 is an enlarged schematic view of a bonding portion of a semiconductor element and a substrate;

FIG. 10 is a perspective view showing a structure of another embodiment of the sub-assembly section of a non-insulation type semiconductor device;

FIG. 11 is an enlarged schematic view of a bonding portion of a semiconductor element and a substrate;

FIGS. 12A and 12B shows a structure of the non-insulating semiconductor device that is one embodiments of the invention;

FIG. 13 is a schematic sectional view of the insulating semiconductor device of the present embodiment;

FIG. 14 is a schematic sectional view of a mini-mold type non-insulating semiconductor device of the embodiment; and

FIG. 15 is a graph showing a grain size of metal particles coated with the organic substance and the shear strength.

### DESCRIPTION OF A PREFERRED EMBODIMENT OF THE INVENTION

Preferred embodiments of the invention will be now explained below.

The invention relates to a conductive sintered layer forming composition using the phenomenon that it is possible to sinter at low temperature as compared to sintering each simple substance, by mixing metal particles that are coated with an organic substance and whose grain size is 1 nm to 5 μm, with silver oxide. The organic substance coating the metal particles is consumed by functioning as medium of particulating the silver oxide into nano-size by heating this composition at temperature of 100° C. or more. It becomes possible to form a conductive sintered layer and to bond at low temperature through the both processes of decomposing the organic substance coating the metal particles at low temperature by the silver oxide and of particulating the silver oxide into the nano-size by the organic substance. It also becomes possible to obtain metallurgical bond with an opposing electrode and to form and bond a conductive coating film, by heating at temperature of more than 100° C. and less than 400° C. by using the conductive sintered layer forming composition of the invention. It is preferable to include a pressurizing process, not only the heating process, to obtain a minuter bond layer and higher bonding strength. It is preferable to set the pressure to a value smaller than 10 MPa in bonding chips and the like that are weak to physical deformation. It is possible to obtain a shear strength of 5 MPa or more at an interface with an electrode by the conductive coating film and the bonding layer formed by this method.

As for the grain size of the metal particle coated with the organic substance, while it is necessary to coat the surface of the metal particle to prevent coagulation among the particles when the grain size is less than 2.3 μm in general or specifically less than 1 μm, it is not necessary to coat the organic substance if the grain size is larger than 5 μm. Therefore, the metal particles having the grain size of 1 nm to 5 μm have been made. However, it is also possible to mix metal particles having a grain size larger than 5 μm, as aggregate for assuring a thickness of the bonding layer or the conductive coating film for example.

Furthermore, although it is possible to mix metal particles having a grain size of 100 nm to 5 μm to generate silver nano-particles from silver oxide constituting the composition by heating, it is preferable to keep the grain size of the metal particles to be 1 to 100 nm by which an excellent low-temperature sintering capability may be obtained from a point of view of obtaining a more minute sintered layer or of alloying by causing a reaction with the silver nano-particles after the organic substance being removed. Thereby, it becomes possible to enhance the degree of sintering with the silver nano-particles generated from the silver oxide and to enhance a reaction rate in alloying after the organic substance being removed.

Still more, as for the grain size of the silver oxide, it is not specifically necessary to limit the size of the silver oxide as compared to the metal nano-particle because the silver oxide is particulated into nano-size by heating, it is preferable to use silver oxide having a grain size of 1 to 50 μm when used for bonding because it is necessary to protect the silver oxide with an organic substance in the same manner as in metal particles when used as particles larger than 1 nm and smaller than 1 μm. However, if it is possible to prevent coagulation by the organic substance contained in the composition, the silver oxide may be used without limit of the grain size and without any problem even when the silver oxide having the grain size larger than 1 nm and smaller than 1 μm is used. However, it is preferable to use silver oxide having a grain size of 50 μm or less because it takes time to particulate into the nano-size if the grain size is large. Furthermore, when a size such as a line width is defined in such as wiring, it is preferable to select metal nano-particles and silver oxide in a grain size range smaller than that size.

There is a case when a melting point of the metal particle coated with the organic substance drops in alloying with silver. Therefore, the metal particle is preferable to be a simple substance selected from a group of Au, Ag, Cu, Ni, Ti, Pt and Pd that are metals whose melting point exceeds at least 300° C. even if alloyed with silver, or two or more types of metal or alloy selected from the group of Au, Ag, Cu, Ni, Ti, Pt and Pd. While a response to lead-free solder has been required currently, it is largely expected for a replacement material to emerge as for high-temperature solder. A mainstream of the present packaging method is to use hierarchical solder and has a characteristic as a melting characteristic required for a bonding portion where the high-temperature solder used (by a primary packaging), that its melting point is higher than packaging temperature of Sn—Ag—Cu solder used mainly in a secondary packaging. There is no decisive replacement material for the high-temperature solder that meets this melting characteristic and provides excellent mechanical characteristics. However, it is possible to meet this characteristic by selecting the type of metals described above because the bonding portion has the melting point far exceeding the temperature of 300° C.

While the organic substance coating the metal particles is an organic substance capable of preventing the coagulation of the metal particles, its coating mode is not specifically defined. However, it is preferable to be an organic substance of more than one type selected from carboxylic acids, alcohols and amines. Here, the organic substances are grouped because they may be changing to anion or cation when they bond chemically or physically with the metal particles and ions and complex originated from the organic substances will be included in the organic substances here.

The carboxylic acid includes caproic acid, enanthic acid, capryl acid, pelargonic acid, caprine acid, undecane acid, lauryne acid, tridecyl acid, myristic acid, pentedecyl acid, palmitic acid, malgarine acid, stearic acid, myristraine acid, palmytraine acid, orein acid, elaidic acid, erucid acid, nervonic acid, linolic acid, linolenic acid, arachidonic acid, eicosapentaen acid, clupanodonic acid, oxalic acid, malonic acid, maleic acid, fumaric acid, succinic acid, glutaric acid, malic acid, adipic acid, citric acid, benzoic acid, phthalic acid, isophtalic acid, terephthalic acid, salichil acid, 2,4-hexagine carboxylic acid, 2,4-heptagine carboxylic acid, 2,4-octagine carboxylic acid, 2,4-decagine carboxylic acid, 2,4-dodecagine carboxylic acid, 2,4-tetradecagine carboxylic acid, 2,4-pentadecagine carboxylic acid, 2,4-hexadecagine carboxylic acid, 2,4-octadecagine carboxylic acid, 2,4-nonadecagine carboxylic acid, 10,12-tetradecagine carboxylic acid, 10,12-pentadecagine carboxylic acid, 10,12-hexadecagine carboxylic acid, 10,12-heptadecagine carboxylic acid, 10,12-octadecagine carboxylic acid, 10,12-tricosagine carboxylic acid, 10,12-pentacosagine carboxylic acid, 10,12-hexacosagine carboxylic acid, 10,12-heptacosagine carboxylic acid, 10,12-octacosagine carboxylic acid, 10,12-nonakosagine carboxylic acid, 2,4-hexagine carboxylic acid, 3,5-octagine carboxylic acid, 4,6-decagine carboxylic acid, 8,10-octadecagine carboxylic acid and the like.

The alcohol includes ether alcohol, propyl alcohol, butyl alcohol, amil alcohol, hexyl alcohol, heputyl alcohol, octyl alcohol, nonyl alcohol, decyl alcohol, undecyl alcohol, dodecyl alcohol, myrystyl alcohol, cetyl alcohol, stearil alcohol, oereil alcohol, rynoril alcohol, ether glycol, triether glycol, glyceline and the like.

The amine includes methyl amine, ether amine, propyl amine, butyl amine, pentyl amine, hexcyl amine, heptyl amine, octyl amine, nonyl amine, decyl amine, undecyl amine, dodecyl amine, tridecyl amine, tetradecyl amine, pentadecyl amine, hexadecyl amine, heptadecyl amine, octadecyl amine, oleilamine, dimethylamin, diethylamine, dipropylamine, dibutylamine, dipenthyamine, dihexylamine, diheptylamine, dioctylamine, dinonylamine, didecylamine, isopropylamine, 1,5-dimethylhexylamine, 2-ethylhexylamine, di(2-ethylhexyl)amine, methylenediamine, trimethylamine, triethylamine, ethylenediamine, hexmethylenediamine, N,N-dimethylpropane-2-amine, aniline, N,N-diisopropylethelamine, 2,4-hexadiinylamine, 2,4-heptadiinylamine, 2,4-octadiinylamine, 2,4-decadiinylamine, 2,4-dodecadiinylamine, 2,4-tetradecadiinylamine, 2,4-pentadecadiinylamine, 2,4-hexadecadiinylamine, 2,4-octadecadiinylamine, 2,4-nonadecadiinylamine, 10,12-tetradecadiinylamine, 10,12-pentadecadiinylamine, 10,12-hexadecadiinylamine, 10,12-heptadecadiinylamine, 10,12-octadecadiinylamine, 10,12-tricosadiinylamine, 10,12-pentacosadiinylamine, 10,12-hexacosadiinylamine, 10,12-heptacosadiinylamine, 10,12-octacosadiinylamine, 10,12-nonacosadiinylamine, 2,4-hexadiinylamine, 3,5-octadiinylamine, 4,6-decadiinylamine, 8,10-octadecadiinylamine, stearic acid amido, palmitic acid amido, lauryne acid lauryl amido, orein acid amido, orein acid diethanol amido, orein acid lauryl amido and the like.

The organic substance for coating the metal particle is preferable to have a molecular structure whose byproducts readily decompose at low temperature in desorbing from the surface of the metal. Furthermore, these organic substances function as a medium in particulating the silver oxide into nano-size when heated together with the silver oxide.

Although it is possible to lower the heating temperature for decomposing the organic substance coating the metal nano-particle by adding the silver oxide largely more than 0, a total amount of organic substance for decomposing the silver oxide at low temperature becomes insufficient and influence of unreacted silver oxide remaining up to high temperature becomes large if the silver oxide is added by more than 400 of weight ratio. Accordingly, the structural ratio of the silver oxide to the metal particles whose surface is coated with the organic substance is preferable to be in a range larger than 0 and smaller than 400 in terms of weight ratio.

Furthermore, as for a compounding amount of the metal particles and silver oxide, a total sum of the metal and silver oxide within the composition is preferred to be in a range of 70 to 95% in terms of weight ratio, from the aspect of the strength of a conductive sintered layer formed.

While the detail of the heating temperature will be described in the first embodiment, it has been set at 100° C. or higher because the organic substance decomposing reaction of the silver oxide starts at 100° C. when the temperature is increased by 1° C./min. of heating speed. Furthermore, results of thermogravimetric analysis have been obtained by carrying the measurement in an atmosphere by using a commercially available instrument capable of thermogravimetric analysis such as TG/DTA6200 manufactured by Seiko Instruments or TGA-50 manufactured by Shimadzu Corporation. Although it is possible to shorten the processing time when the temperature is higher than those described above, it is not necessary to increase the heating temperature more than 400° C. because the process is completed in the temperature increasing step even if the heating temperature is increased more than that temperature.

While a detail will be explained in the second embodiment, it is possible to lower the conductive sintered layer forming temperature by mixing silver oxide with the metal nano-particles coated with the organic substance as shown in FIG. 2. However, because the amount of the organic substance for reducing silver oxide at low temperature becomes insufficient if the weight ratio of silver oxide within the composition exceeds 80 wt. %, the residual ratio of silver oxide within the sintered layer increases. However, it is possible to reduce silver oxide remaining within the sintered layer at low temperature by adding the reducing agent in the composition. The reducing agent to be added is preferable to be alcohols, carboxylic acids, amines or the like.

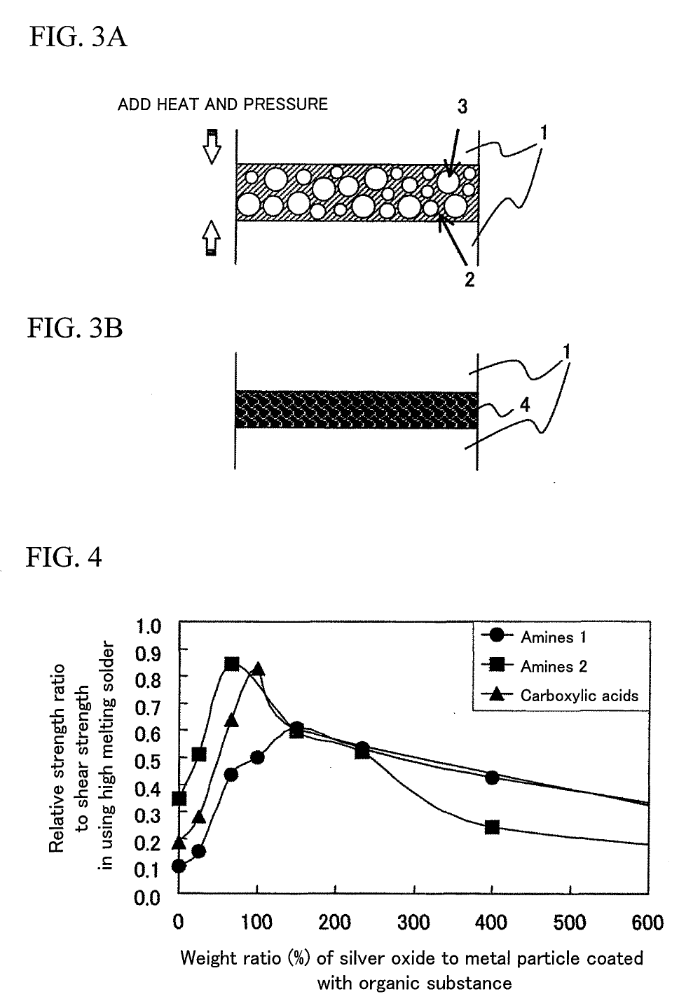

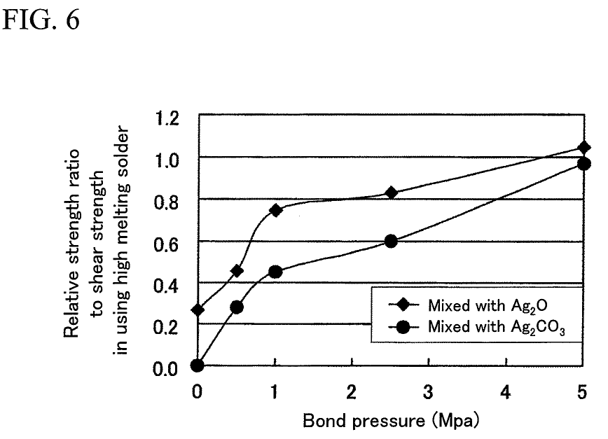

A bonding method using the conductive sintered layer forming composition containing metal particles 2 whose surface is coated with the organic substance of the invention and silver oxide 3 will be explained with reference to FIG. 3. By inserting the conductive sintered layer forming composition between the materials 1 to be bonded and by implementing a heating process of more than 100° C. and less than 400° C., the surface of the metal particle 2 is exposed due to the decomposition of the organic substance, and the silver nano-particle is generated from the silver oxide 3. Then, a sintered layer 4 is formed as the materials 1 are bonded by the sintering among the particles. Furthermore, while a detail will be explained in a fourth embodiment, it is possible to enhance the strength of the bonding portion as shown in FIG. 6 by adding a pressurization process with a pressure of larger than zero in addition to the heating process. Effects of the pressurization is to compensate for a contraction of volume accompanying the decomposition from silver oxide to metal silver as shown in Table 1 and to compensate for a contraction of volume accompanying the decomposition of the organic substance coating the metal particles. It also has an effect of promoting exhaustion of organic gas component oxidized and decomposed from the silver oxide to the outside of the bonding layer. The pressure is reduced to a load smaller than 10 MPa when a chip that is weak to physical deformation is bonded for example. It is because the to-be-bonded chip is broken if pressure more than 10 MPa is added as shown in Table 2.

TABLE 1

| | | CHANGES |
|---|---|---|
| | CHANGES OF WEIGHT | OF VOLUME |
| Ag₂CO₃ → 2Ag | 78.2 WT. % | 45.3 VOL. % |
| Ag₂O → 2Ag | 93.1 WT. % | 64.0 VOL. % |

TABLE 2

| | | | |
|---|---|---|---|
| PRESSURE (MPa) | 1.0 | 5.0 | 10.0 |
| STATE OF CHIP | ◯ | ◯ | X |

◯: NO BREAKING
X: BREAKING EXISTS

As shown in FIG. 6, it is possible to give a strength of 5 MPa or more to the electrodes even if no pressure is given, by forming the conductive sintered layer by use of the conductive sintered layer forming composition containing both the metal particles whose surface is coated with the organic substance and the silver oxide, according to the invention.

The strength of the conductive coating film and the bonding strength after bonding is set at 5 MPa or more because it is considered that the effect by the metallurgical bond starts to appear by 5 MPa or more in the bonding interface. Table 3 shows a shear strength and observation results of a fracture surface when a shearing test has been carried out about the bonding made by using the bonding method of the invention. Table shows the results when joints were fabricated by using a sample A composed of only the silver oxide particles and by using samples B, C and D composed of the compositions made by mixing the metal particles coated with the organic substance with the silver oxide at weight ratios of 3:2, 2:3 and 1:9, respectively. The bonded joints fabricated by the samples A through D will be called as joints A through D. As a observation result of the fracture surface, a main breaking mode of the joints A and D is interfacial fracture between the materials to be bonded and the silver oxide, and their shear strengths have been 5 MPa or less. The breaking of the joints B and C by a shear strength of 5 MPa or more has been a breaking within the sintered silver layer. When the fracture surface of the sample is caused by the breaking at the interface, the breaking mainly occurs by bonding due to an anchor effect and the breaking within the sintered silver layer is caused mainly by the metallurgical bond. Thereby, the shear strength of 5 MPa or more of the sample obtained by the bonding method of the invention is defined as the strength that starts to appear as the effect of the metallurgical bond.

TABLE 3

| | SAMPLE | | | |
|---|---|---|---|---|
| | A | B | C | D |
| SHEAR | LESS THAN | MORE | MORE THAN | LESS THAN |
| STRENGTH | 5 MPa | THAN | 5 MPa | 5 Mpa |
| | | 5 MPa | | |
| MAIN | X | ◯ | ◯ | X |
| BREAKING | | | | |
| MODE | | | | |

X: INTERFACIAL FRACTURE
◯: BREAKING WITHIN BONDING LAYER

Although the conductive sintered layer forming composition composed of the metal particles whose surface is coated with the organic substance and the silver oxide may be used as it is, it may be supplied as ink, paste or a sheet so as to be able to readily apply or to print. When it is used as ink or paste, it is possible to add a solvent such as water and an organic solvent as dispersion medium. As the solvent, it is possible to use alcohols having a reduction effect to silver oxide, such as methanol, ethanol, propanol, ethylene glycol, triethylene glycol and telpineol if it is used immediately after mixing, but it is preferable to use one whose reducing effect to silver oxide is weak at normal temperature, such as water, hexane, tetrahydrofrane, toluene and cychrohexane if it is stored for a long period of time.

As for the paste material, there are methods of injecting the paste from a fine nozzle by means of ink-jet to apply to areas for connecting electrodes or electronic parts on the substrate, of applying only to required areas by using a metal mask or meshed mask in which areas corresponding to the areas to be applied are opened, of applying to required areas by using a dispenser, of applying water repellent resin including silicone and fluorine by the metal mask or meshed mask in which only required areas are opened, and either applying photosensitive water repellent resin to the substrate or the electronic parts, or exposing and developing, to remove area where the paste composed of the fine particles is to be applied and then applying bonding paste to the resultant opening area, and furthermore of applying water repellent resin to the substrate or the electronic parts and removing the area to which the paste made of the metal particles is applied, by a laser and then applying the bonding paste to the resultant opening area. These application methods may be combined according to an area and shape of an electrode to be bonded.

Furthermore, it is possible to mold into a shape of a sheet by mixing the metal nano-particles coated with the organic substance and silver oxide and by adding pressure and to use it as a bonding material. It is possible to mold the sheet by adding an organic substance that is solid at room temperature, such as myristill alcohol, cetyl alcohol, stearyl alcohol, caprine acid, undecane acid, lauryne acid and myristic acid when the reducing agent described above is required.

While there is a case of adding the solvent such as water and organic solvent and the reducing agent to put into the state of ink and paste so as to able to readily apply or print, a total sum of the metal and silver oxide within the composition is preferable within a range of 70 to 95% in terms of weight ratio. If it is smaller than 70%, it becomes difficult to density the sintered layer because the amount of organic substance occupied within the composition becomes too large and if it exceeds 95%, the influence of unreacted silver oxide becomes remarkable.

A member for fixing a semiconductor element is one of electrodes of a semiconductor device in the non-insulating semiconductor device that is one of power semiconductor device used in an inverter or the like. For example, in a semiconductor device in which a power transistor is mounted on a fixed member by using an Sn—Pb soldering material conventionally used, the fixing member (base material) becomes a collector electrode of the power transistor. An electric current of several A or more flows through this collector electrode portion when the semiconductor device is operative and the transistor chip generates heat. It is necessary to dissipate the heat generated during the operation of the semiconductor device efficiently to the outside of the package and to assure connection reliability of the bonding portion in order to operate the semiconductor element safely and stably. In order to avoid the instability of the characteristics and drop of life caused by the heat thus generated, it must be able to assure the heat radiating property and a long-term reliability (heat resistance) of the bonding portion. That is, high heat radiating material is required in order to assure the heat resistance and heat radiating property of the bonding portion. Then, the bonding portion obtained by the invention is composed of metal silver or an alloy layer of the metal silver, as a main substance, and Au, Cu, Ni, Ti, Pt and Pd, so that it has excellent heat resistance and heat radiating property. The semiconductor device utilizing this characteristic will be explained in detail in fifth through tenth embodiments.

It is possible to lower the heating temperature and to shorten the heating time as compared to the prior art process of forming the conductive sintered layer by using the metal nano-particles coated with the organic substance, by forming the conductive sintered layer by heating by using the conductive sintered layer forming composition described above. Still more, it is possible to achieve the lowering of the heating temperature, shortening of the heating time and reduction of pressure in bonding as compared to the process of bonding by heating and pressurizing by using the metal nano-particles coated with the organic substance.

Furthermore, although it has been difficult to lower the cost because it has been costly to fabricate the metal nano-particles as compared to the prior art soldering material and because it takes time to refine the organic substance after fabricating the nano-particles, it becomes possible to lower the cost considerably by adding silver oxide whose price is much lower than the metal nano-particles.

It is also possible to reduce a content of impurities such as the organic substance in the conductive sintered layer formed because substances produced by the decomposition of silver oxide are oxygen and metal silver and because the organic substance contained within the composition can be reduced relatively by adding silver oxide.

Furthermore, it is possible to fabricate electronic parts and semiconductor packages that can assure the long-term reliability even under a high-temperature environment by applying the conductive sintered layer forming composition to the electronic pars and semiconductor packages.

The embodiments of the invention will be explained below with reference to the drawings.

### First Embodiment

The invention utilizes the conductive sintered layer forming composition using the phenomenon that it is possible to sinter at low temperature as compared to sintering each simple substance, by mixing metal particles coated with the organic substance, with silver oxide.

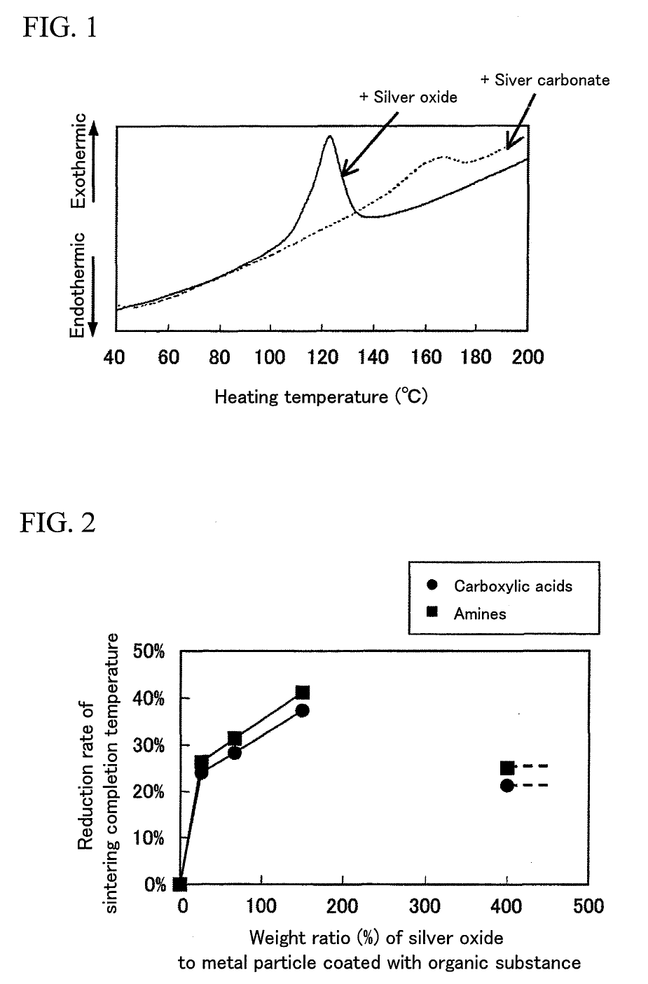

In order to confirm this phenomenon, the effect obtained by mixing the silver oxide particles with the metal particles coated with the organic substance has been studied in the first embodiment. The silver oxide particles having an average grain size of about 2 μm and silver nano-particles having a grain size of 1 to 100 nm are used while using carboxylic acids as the organic substance for coating the metal particles. FIG. 1 shows results of a thermal analysis of the composition in which silver oxide is mixed in terms of weight ratio of 100 to the silver nano-particles coated with the carboxylic acids. The thermal measurement has been carried out in an atmosphere by using TG/DTA6200 manufactured by Seiko Instruments and by setting the rate of temperature rise to 1° C./min. An exothermic peak was detected in the heating temperature from about 100° C. to about 140° C. This exothermic peak is a peak that does not exist in the case of each simple substrate and as a result of XRD analysis carried out for the composition after the exothermic peak, no peak of silver oxide that has existed before the exothermic peak was not seen. This exothermic reaction is an oxidation-reduction reaction between the carboxylic acids coating the silver nano-particles and silver oxide, showing that the organic substance coating the metal particles may be decomposed at the heating temperature of about 100° C. to about 140° C. by mixing silver oxide.

In order to compare and study the invention with composition of silver carbonate that is the prior art technology, thermal analysis of a composition in which silver carbonate has been mixed at a weight ratio of 100 to the silver nano-particle coated with the carboxylic acids has been implemented. As a result, the exothermic peak was detected in the same manner, showing that silver carbonate decomposed the carboxylic acids coating the silver nano-particles. However, the decomposition was carried out at heating temperature from about 140° C. to 180° C. Thus, it was shown that the conductive sintered layer could be formed at temperature lower that of the prior art, by using the metal particles coated with the organic substance.

### Second Embodiment

The conductive sintered layer may be fabricated at low processing temperature by using the conductive sintered layer forming composition of the invention. FIG. 2 is a graph showing a temperature lowering rate of the process completion temperature to a case when a simple substance of the metal particle coated with the organic substance is used. The silver nano-particles having a grain size of 1 to 100 nm and coated with carboxylic acids and the silver nano-particles having a grain size of 1 to 1000 nm and coated with amines have been used as the metal particles coated with the organic substance, and silver oxide particles having an average grain size of about 2 μm are mixed with each of them so as to be in the weight ratio represented by an axis of abscissa in FIG. 2. Only the temperature raising process has been given as the heating process with heating speed of 10° C./min. in order to eliminate an influence of holding time in the heating process. The process has been finished at a temperature by which the decompositions of the organic substance and silver oxide are finished, i.e., at a temperature by which the reduction of weight is finished. The heating temperature has been risen up to 1000° C. by which metal silver melts to confirm that the reduction of weight has been finished. The reduction of weight has been measured by using TG/DTA6200 manufactured by Seiko Instruments. The measurement was carried out in atmosphere. The temperature lowering rate of the process completing temperature was defined by dividing a difference between process completing temperature when the simple substance of the silver nano-particles coated with the organic substance is used and process completing temperature when the silver oxide is added, by the process completing temperature when the simple substance of the silver nano-particles coated with the organic substance is used. As shown in FIG. 2, it is possible to lower the heating temperature by 20% or more by adding the silver oxide within the composition.

Still more, it is possible to lower the heating temperature by about 40% when the weight ratio of the silver oxide to the metal particles coated with the organic substance is 150.

In order to study a state of the sintered silver layer after completion of the process, the weight ratio of silver oxide within the composition was changed in the same manner as described above and then the composition was heated up to the process completing temperature. Immediately after that, it was quenched to observe by an optical microscope. When the sintering of the silver nano-particles and silver oxide has been completed, the sintered layer is contrasted in white. As a result, it was confirmed that the sintered silver layer has been formed by heating up to each process completing temperature. Still more, because the amount of the organic substance for reducing silver oxide at low temperature becomes insufficient if the weight ratio exceeds 80 wt. %, the temperature lowering rate of the heating temperature saturates. Therefore, the compositional ratio of silver oxide to the metal particles whose surface is coated with the organic substance is preferred to be in a range of weight ratio larger than 0 and smaller than 400.

### Third Embodiment

A point that it becomes possible to obtain high bonding strength at low temperature by using the conductive sintered layer forming composition of the invention as a bonding material as compared to a case of using the simple substance of the metal particles coated with the organic substance will be explained below.

The silver nano-particles having a grain size of 1 to 100 nm and coated with carboxylic acids, the silver nano-particles having a grain size of 1 to 10 nm and coated with amines and the silver nano-particles having a grain size of 1 to 1000 nm and coated with amines have been used as the metal particles coated with the organic substance. Then, the conductive sintered layer forming composition of the invention was obtained by mixing silver oxide particles having an average grain size of about 2 μm with the respective silver nano-particles so that the content of silver oxide within the composition becomes as indicated by the weight ratio represented by an axis of abscissa in FIG. 4.

As bonding test pieces used in the measurement, a disk-like test piece having a diameter of 5 mm and a thickness of 2 mm was used as an upper side piece and a disk-like test piece having a diameter of 10 mm and a thickness of 5 mm was used as a lower side piece. Silver plating had been applied to their surface. The bonding material described above was placed between these upper and lower test pieces to bond by applying heating and pressurizing processes. Bonding conditions were as follows: a bonding highest heating temperature of 300° C., a bonding time of 150 s and a bonding pressure of 2.5 MPa. The bonding time is a total sum of time during when the temperature was raised from the room temperature to the bonding temperature and during when the test pieces were held at the highest heating temperature.

Next, strength of the bonding portion was measured under pure shearing stress by using a bonding joint fabricated by the bonding conditions described above. A bond tester SS-100KP (maximum load: 100 kg) manufactured by Saishin Corporation was used for the shearing test. The test pieces were ruptured by a shearing tool at a shearing speed of 30 mm/m to measure a maximum load during the rupture. A value obtained by dividing the maximum load obtained as described above by a bonding area was defined as the shear strength.

As an index of the shear strength when the bonding material of the present embodiment was used, the strength ratio relative to the shear strength of the bonding joint fabricated under a bonding temperature of 350° C., a bonding time of 300 s and no pressure using a high melting point solder, was used. FIG. 4 shows its results. The high melting point solder is an alloy whose main components are Sn and Pb and having a melting point between 280° C. and 300° C.

It can be seen from FIG. 4 that the bonding strength increases by mixing the metal particles coated with the organic substance with silver oxide as compared to a case of using the simple substance of the metal particles coated with the organic substance. It is because the mixed silver oxide accelerates the decomposition of the organic substance coating the metal particles and because the organic substance gas decomposed from the bonding layer is readily emitted by adding silver oxide because the amount of the organic substance contained in the entire composition may be reduced.

It can be also seen that the bonding strength increases by adding the metal particles coated with the organic substance to the simple substance of silver oxide. It is because the organic substance coating the metal nano-particles functions as a medium for particulating silver oxide into silver nano-particles and because the metallurgical bond with the material to be bonded is achieved due to a sizing effect of the generated silver nano-particles and the metal nano-particles whose organic substance has been removed.

It was thus shown that both the sintering within the bonding layer and the bonding with the materials to be bonded advance at a low temperature in a short time by the decomposition accelerating effect of the silver oxide of decomposing the organic substance coating the nano-particles within the bonding layer and the effect of the organic substance for generating the silver nano-particles from silver oxide.

Although it is possible to lower the heating temperature for decomposing the organic substance coating the metal nano-particles by adding silver oxide more than zero as shown in FIG. 4, when the weight ratio is 400 or more, a total amount of the organic substance for decomposing silver oxide at a low temperature becomes insufficient, an influence of unreacted silver oxides remaining up to high temperature increases and the strength drops. Therefore, the composition ratio of silver oxide to the metal particles whose surface is coated with the organic substance is preferred to be in the range of weight ratio larger than zero and smaller than 400.

Because the optimum mixing ratio differs depending on the type of the organic substance coating the metal particles and on the grain size as shown in FIG. 4, it is necessary to use the optimum mixing rate suited to the metal particles coated with the organic substance. It can be also seen that the shear strength is large by the particles designed so as to be able to decompose the organic substance at a lower temperature. Therefore, preferably the metal particle is coated with the organic substance having a molecular structure that allows bi-products generated when the organic substance coating the metal nano-particles is desorbed from the surface of the metal, to be readily decomposed at low temperature.

### Fourth Embodiment

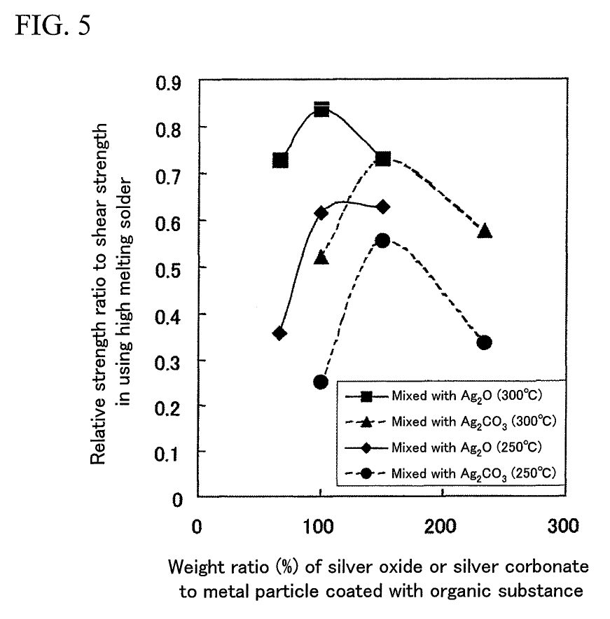

The case of adding silver carbonate of the prior art technology was compared with the case of adding silver oxide of the invention in the present embodiment. As the metal particles coated with the organic substance, the silver nano-particles coated with the carboxylic acids and having a grain size of 1 to 100 nm were used. Then, the silver oxide particles having an average grain size of about 2 μm and the silver carbonate were mixed with their respective silver nano-particles so that the content of them within their respective compositions become as indicated by the weight ratio represented by an axis of abscissa in FIG. 5. A test piece used for the measurement was a disk-like test piece having the similar shape with that of the third embodiment. Au plating had been applied also to their surface. The bonding material described above was placed between these upper and lower test pieces to bond by applying heating and pressurizing processes. Bonding conditions were as follows: bonding highest heating temperatures of 250 and 300° C., a bonding time of 150 s and a bonding pressure of 2.5 MPa. The maximum load was measured similarly to the third embodiment to find the shear strength. As an index of the shear strength when the bonding material of the present embodiment was used, the strength ratio relative to the shear strength of the bonding joint fabricated under a bonding temperature of 350° C., a bonding time of 300 s and no pressure using the high melting point solder, was also used. FIG. 5 shows its results.

As shown in FIG. 5, the strength increasing effect of the case of using silver oxide is large as compared to the case of using silver carbonate. It may be because (1) silver oxide starts its reaction to the organic substance coating the metal particles at lower temperature than silver carbonate does as shown in FIG. 1, (2) as shown in Table 1, while silver carbonate causes a large contraction of volume of 45.3 vol. % from silver carbonate to metal silver, silver oxide causes 64.0 vol. % and is capable of reducing an influence of contraction of volume, and (3) while silver carbonate generates a large amount of CO₂ gas before reacting with the organic substance, hampering the advance of sintering and bonding, silver oxide generate no CO₂ gas. Thus, it becomes possible to lower the bonding temperature, to shorten the bonding time and to reduce the bonding pressure as compared to the prior art technology.

Still more, in order to study the effect of pressurization, it was tested by using a composition having 100 wt. % of silver oxide to the metal particles coated with the organic substance that was considered to the optimum rate in FIG. 5 and a composition having 150 wt. % of silver carbonate. The bonding conditions were as follows: The bonding highest heating temperature is 300° C. and the bonding time is 150 s. The bonding pressure was changed respectively to 0, 0.5, 1.0, 2.5 and 5.0 MPa. It can be seen from FIG. 6 that high strength may be obtained at low pressure by using silver oxide. Further, it is a characteristic of the invention differing from the prior art materials that the strength may be obtained even under no pressure. However, it also shows that the minuteness of the bonding sintered layer is accelerated and the strength increases by increasing the pressure while bonding.

### Fifth Embodiment

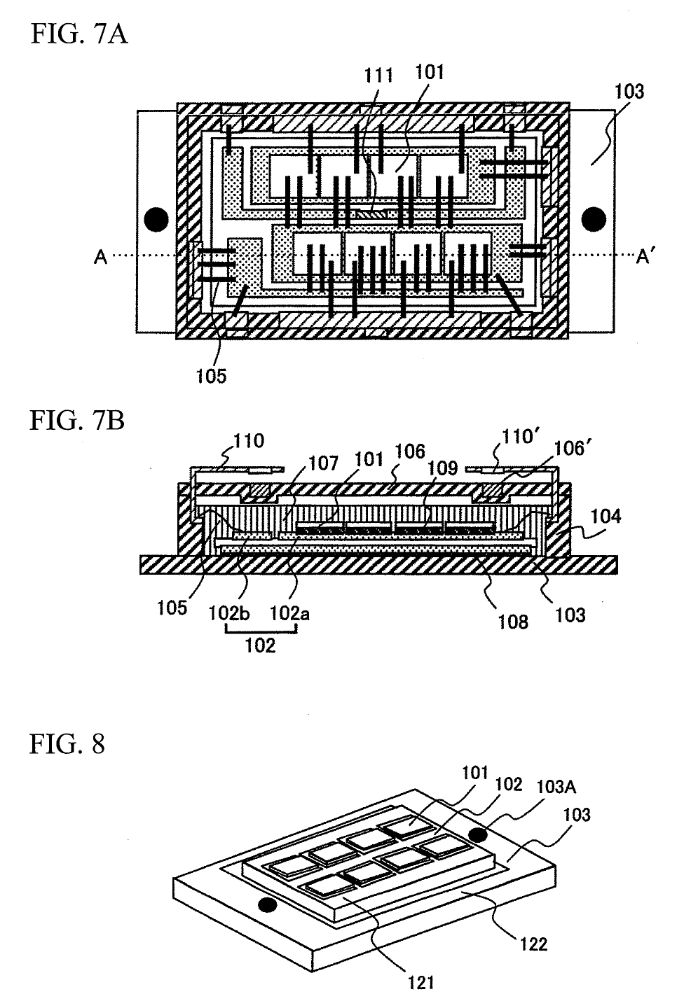

FIGS. 7A and 7B show a structure of a non-insulating type semiconductor device that is one of the embodiments of the invention. FIG. 7A is an upper plan view thereof and FIG. 7B is a section view along a part A-A′ in FIG. 7A. After mounting a semiconductor element (MOSFET) 101 on a ceramic insulating substrate 102 and mounting the ceramic insulating substrate 102 on a base material 103, respectively, and providing a epoxy resin case 104, a bonding wire 105 and an epoxy resin led 106, silicone gel resin 107 was filled into the same case. Here, the ceramic insulating substrate 102 on the base material 103 is bonded by a bonding layer 108 formed by the conductive sintered layer forming composition in which silver oxide particles are mixed with silver particles coated with the carboxylic acids and having a grain size of 1 to 1000 nm at a weight ratio of 100, and are dispersed in toluene, and the eight MOSFET elements 101 made from Si are bonded on a Cu electrode 102a of the ceramic insulating substrate 102 by a bonding layer 109 formed of the conductive sintered layer forming composition.

The bonding by the bonding layers 108 and 109 formed by the conductive sintered layer forming composition in which the silver oxide particles are mixed with the silver particles coated with the carboxylic acids so that the weight ratio becomes 100, and are dispersed in toluene, is carried out as follows. At first, the conductive sintered layer forming composition is applied on the Cu electrode 102a (whose surface is plated by Ni) of the ceramic insulating substrate 102 and on the base material 103. Next, the semiconductor element 101 and the ceramic insulating substrate 102 are placed on the conductive sintered layer forming compositions. Then, they are heated up to about 250° C. and are bonded by the bonding conditions of 300 s and a pressure of 1 MPa.

A gate electrode, an emitter electrode and others formed on each element 101, electrodes 102a and 102b formed on the insulating substrate and terminals 110 attached in advance to the epoxy resin case 104 are wire-bonded by using bonding wires 105 made of an Al wire having a diameter of 300 μm by means of ultrasonic bonding. A thermister element 111 for detecting temperature is structured by the bonding layer 109 formed from the conductive sintered layer forming composition described above and is made a communication to the outside by wire-bonding the electrode 102a and the terminal 110 by use of the Al wire having a diameter of 300 μm.

It is noted that the epoxy resin case 104 was fixed to the base material 103 by using silicone adhesive resin (not shown). A recess 106′ is provided in an inner thickness part of an epoxy resin led 106 and a hole 110′ is provided in the terminal 110, respectively, so as to attach a screw (not shown) for connecting the insulating semiconductor device 1000 with an outside circuit. The terminal 110 is a Cu plate which is punched into a predetermined shape in advance, and is molded and is plated by Ni and which is attached to the epoxy resin case 104.

FIG. 8 is a perspective view showing a sub-assembly section of the insulating type semiconductor device shown in FIG. 7 in which the ceramic substrate and the semiconductor elements are mounted on the base material 103 of the composite material. The base material 103 is provided with mounting holes 103A at peripheral parts thereof. The base material 103 is made of Cu whose surface is plated by Ni. The bonding layer made from the conductive sintered layer forming composition and the ceramic insulating substrate 102 are mounted on the base material 103, and the MOSFET elements 101 are mounted on the ceramic insulating substrate 102 through the bonding layer formed from the conductive sintered layer forming composition, respectively.

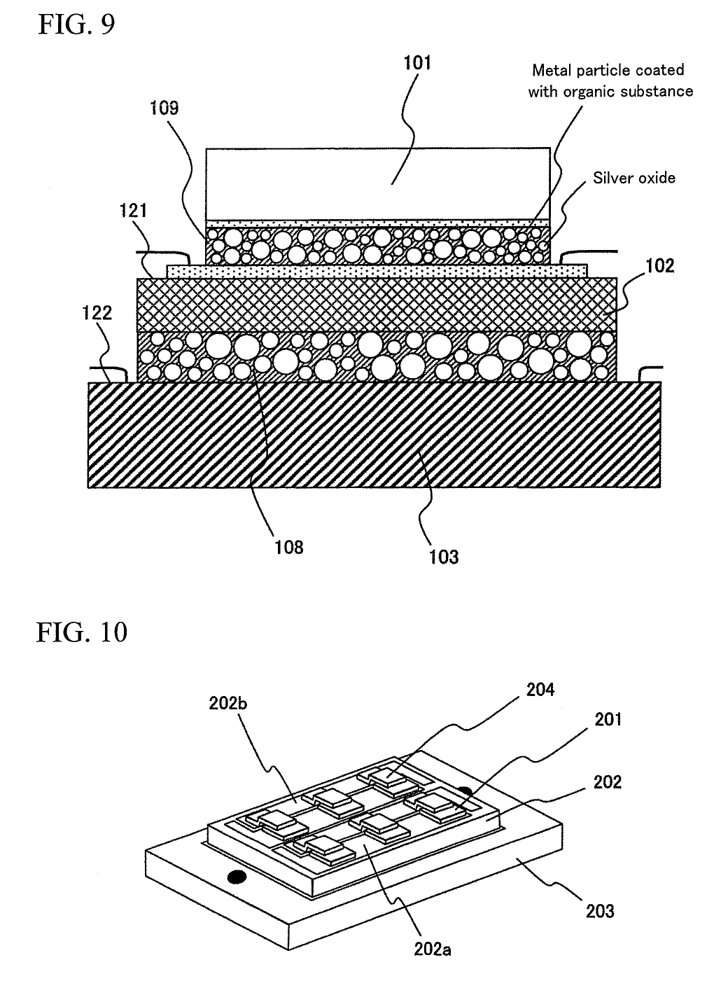

FIG. 9 is an enlarged schematic view of a section of a MOSFET element mounting section in FIG. 8 before bonding. As shown in FIG. 9, it is possible to use the conductive sintered layer forming composition in which the silver oxide particles are mixed with the metal nano-particles coated with the organic substance so that the weight ratio becomes 100, and are dispersed in toluene, as the bonding layer. Furthermore, a water repellent film 122 is applied on the base material 103 so as to correspond to an area for mounting the ceramic insulating substrate 102 to prevent a flow of solution in applying the paste material. Still more, a water repellent film 121 is applied on the ceramic insulating substrate 102 so as to correspond to an area for mounting the semiconductor elements 101 to prevent a flow of solution in applying the paste material.

### Sixth Embodiment

FIG. 10 is a perspective view showing another embodiment of the non-insulation type semiconductor device using the conductive sintered layer forming composition of the invention.

Semiconductor elements 201 are bonded with a ceramic insulating substrate 202 by the conductive sintered layer forming composition in which the silver oxide particles are mixed with the silver particles coated with the carboxylic acids and having a grain size of 1 nm to 3.5 μm so that the weight ratio becomes 100 and which is formed into a sheet by pressurizing. A Cu wire 202b which is formed on the ceramic insulating substrate and whose surface is plated by Au and Ni, is connected to an emitter electrode of the semiconductor element via a connecting terminal 204 by the conductive sintered layer forming composition.

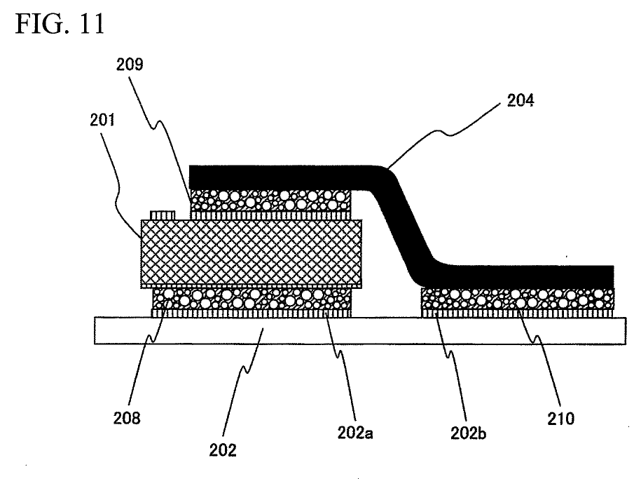

FIG. 11 is an enlarged schematic section view of a semiconductor element mounting section in FIG. 10 before bonding. The connecting terminal (Cu plate) 204, the Cu wires 202a and 202b on the insulating substrate 202 are plated respectively by Ni and Au from the side of Cu.

At first, a conductive sintered layer forming composition 208 is provided between the Cu wire 202a of the insulating substrate and the semiconductor element 201 and then a conductive sintered layer forming composition 209 is provided on the emitter electrode (upper side) of the semiconductor element. Furthermore, a conductive sintered layer forming composition 210 is provided between an Au plated portion of the wire 202b and the connecting terminal 204. After mounting them, the connection of the conductive sintered layer forming compositions 208 through 210 is completed by heating them up to about 250° C. under the bonding conditions of 300 s and a pressure of 0.5 Mps. Because a large current flows not only through the collector electrode but also through the emitter electrode part in the insulating semiconductor device, it is possible to enhance the reliability of connection of the emitter electrode side by using the large connecting terminal 204 having a large wire width.

### Seventh Embodiment

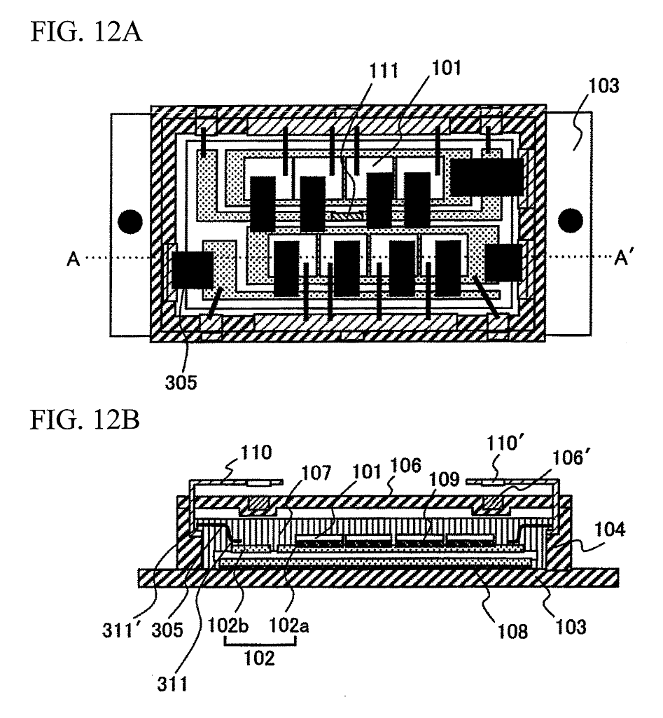

FIGS. 12A and 12B shows a structure of the non-insulating semiconductor device similar to one in the fifth embodiment. The bonding wire 105 in the fifth embodiment is formed into a clip-like connecting terminal 305 in the present embodiment. The communication of the gate electrode, emitter electrode and others formed on each element 101, the electrodes 102a and 102b formed on the insulating substrate and the terminal 110 mounted in advance to the epoxy resin case 104 is made to the outside by using the clip-like connecting terminal 305 and via a bonding layer 511 formed from the conductive sintered layer forming composition in which the silver oxide particles are mixed with the silver particles coated with the carboxylic acids and having a grain size of 1 to 100 nm so that the weight ratio becomes 100. The bonding is carried out by heating up to 250° C. and then by holding for 120 s and by applying a load of about 0.1 MPa during that.

### Eighth Embodiment

An insulating semiconductor device as a high-frequency power amplifier used in a transmitting section of a cellular telephone or the like will be explained in the present embodiment.

The insulating semiconductor device (size: 10.5 mm×4 mm×1.3 mm) of the present embodiment is constructed as follows.

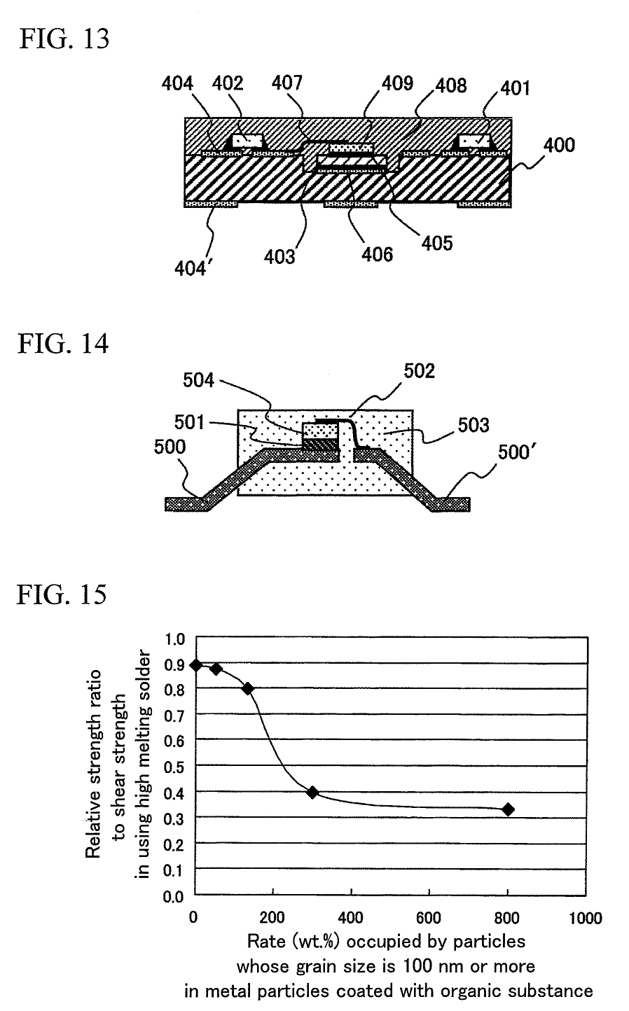

FIG. 13 is a schematic sectional view of the insulating semiconductor device of the present embodiment. Here, chip parts including a MOSFET element (size: 2.4 mm×1.8 mm×0.24 mm) 409, a chip resistor (about 7 ppm/° C.) 401 and a chip capacitor (about 11.5 ppm/° C.) 402 are mounted on a multi-layered glass ceramic substrate (size: 10.5 mm×4 mm×0.5 mm, three layered wiring, thermal expansion rate: 6.2 ppm/° C., thermal conductivity: 2.5 W/m.K, bending strength: 0.25 GPa, Young's modulus: 110 GPa and dielectric constant: 5.6 (1 MHz)) as a holding member 400. An intermediate metal member 103 made from a Cu—CU₂O composite material for example is provided between the MOSFET element 409 and the multi-layered glass ceramic substrate 400. A thick film inner layer wiring layer (Ag—1 wt. %, 1 Pt, thickness: 15 μm), a thick film through hole conductor (Ag—1 wt. %, 1 Pt, diameter: 140 μm) for electrical communications among the multi-layered wirings and a thick film thermal via (Ag—1 wt. %, 1 Pt, diameter: 140 μm) as a heat radiating path are provided within the multi-layered glass ceramic substrate 400. A thick film wiring pattern (Ag—1 wt. %, 1 Pt, thickness: 15 μm) 404 is provided on one main face of the multi-layered glass ceramic substrate 400. The chip parts including the chip resistor 401 and the chip capacitor 402 are conductively secured on the thick film wiring pattern 404 by a sintered silver layer 405 obtained by applying the conductive sintered layer forming composition in which the silver oxide particles are mixed with the silver particles coated with amines and having a grain size of 1 to 1000 nm so that the weight ratio becomes 100, and are dispersed in toluene, to the thick film wiring pattern and by applying a load of 0.5 MPa for 120 s to the chip parts at 300° C. The MOSFET element (Si, 3.5 ppm/° C.) 409 is mounted on a recess provided on one main surface of the multi-layered glass ceramic substrate 400 via the intermediate metal member 403. It was mounted in vacuum of 10⁻³. The size of the intermediate metal member 403 is 2.8 mm×2.2 mm×0.2 mm. Here, the sintered silver layer 405 for connecting the MOSFET element 409 with the intermediate metal one 403 and the bonding layer 406 for connecting the intermediate metal one 403 with the multi-layered glass ceramic substrate 400 are all layers formed by using the conductive sintered layer forming composition. A clip-type connecting terminal 407 made from Cu is bonded by using the conductive sintered layer forming composition between the MOSFET element 409 and predetermined portions of the thick film wiring pattern 404. At this time, the bonding was carried out by applying a load of 0.1 MPa for 2 min. at 30° C. A thick film outside electrode layer 404′ (Ag—1 wt. %, 1 Pt, thickness: 15 μm) is provided on the other main face of the multi-layered glass ceramic substrate 400. The thick film outside electrode layer 404′ is electrically connected with the thick film wiring pattern 404 via the inner wiring layer and through hole wires provided within the multi-layered glass ceramic substrate 400. An epoxy resin layer 408 is provided on one main face of the multi-layered glass ceramic substrate 400 to seal the mounted chip parts and others.

### Ninth Embodiment

The non-insulating semiconductor device in which the complex material is applied as a lead frame for a mini mold type transistor will be explained in this embodiment.

FIG. 14 is a schematic sectional view of a mini-mold type non-insulating semiconductor device of the embodiment. A transistor element (size: 1 mm×1 mm×0.3 mm) made from Si as a semiconductor element 504 is bonded to a lead frame (thickness: 0.3 mm) 500 made from a Cu—Cu₂O composite material for example by a bonding layer 501 fabricated by applying the conductive sintered layer forming composition in which the silver oxide particles are mixed with the silver particles coated with carboxylic acids and having a grain size of 1 nm to 5 μm so that the weight ratio becomes 100, and are dispersed in toluene, to the lead frame 500 and then by applying a load of 2.0 MPa for 120 at 300° C. A collector of the transistor element 504 is disposed on the side bonded by using the conductive sintered layer forming composition. An emitter and a base are provided on the side opposite to the side bonded by the conductive sintered layer forming composition. A clip-like terminal 502 drawn out of the transistor element 504 is bonded with a lead frame 500 by using the conductive sintered layer forming composition. The bonding is carried out by applying a load of 2.0 MPa for 120 s at 300° C. to the clip-like terminal. A main part in which the transistor element 504 and the clip-like terminal 502 are mounted is covered by an epoxy resin 503 by means of transfer mold. The lead frame 500 is separated in the stage when the molding by the epoxy resin 503 is completed, and functions are given as independent terminals.

### Tenth Embodiment

It is possible to improve a heat radiating property more than prior art solder or thermal conductive adhesives by means of bonding by using the conductive sintered layer forming composition of the invention in packaging a LED on a substrate.

### Eleventh Embodiment

FIG. 15 is a graph showing a result obtained by studying a relationship of a grain size with shear strength by varying a weight ratio of particles having a grain size of 100 nm to 5 μm to particles having a grain size of 1 to 100 nm in the silver particles coated with carboxylic acids. The silver oxide particles having an average grain size of about 2 μm are mixed with the silver particles with the weight ratio to 100 being fixed. Disk-like test pieces having a similar shape to that of the third embodiment were used for the measurement. Their surface is plated by Ag. They are boded by placing the bonding material described above between the upper and lower test pieces and by applying heating and pressurizing processes. The bonding conditions were a bonding highest heating temperature of 300° C., a bonding time of 150 s and a bonding pressure of 2.5 MPa. The shear strength was measured by measuring the maximum load in the same manner as in the third embodiment. As an index of the shear strength when the bonding material of the present embodiment was used, the strength ratio relative to the shear strength of the bonding joint fabricated under a bonding temperature of 350° C., a bonding time of 300 s and no pressure using the high melting point solder, was used.

As shown in the figure, it can be seen that the particles having the grain size of 1 to 100 nm are preferable to obtain the stronger sintered layer.

### Twelfth Embodiment

A method for forming a wire using the conductive sintered layer forming composition of the invention will be explained in this embodiment. Silver nano-particles coated with carboxylic acids and having a grain size of 1 to 100 nm was used as a comparative material of the prior art technology. A volume resistivity of the wire formed by mixing silver oxide particles having an average grain size of about 2 μm with the silver nano-particles at a weight ratio of 100 was measured by a four-terminal method. The wire was fabricated by transforming the both into paste by dispersing in terpineol, by applying on the substrate and by heating at 180° C. for 900 s. As a result, a silver wire having a smaller volume resistivity by one order than the prior art one was fabricated as shown in Table 4. Thus, it becomes possible to improve an electrical resistance of the wire formed by adding silver oxide to the metal particles coated with the organic substance.

TABLE 4

| | VOLUME RESISTIVITY (Ω · cm) |
|---|---|
| PRIOR ART MATERIAL | 1.05 × 10⁻⁴ |
| PRESENT INVENTION | 1.26 × 10⁻⁵ |

1. A conductive sintered layer forming composition, containing metal particles whose surface is coated with an organic substance and whose grain size is 1 nm to 5 μm and silver oxide particles.

2. The conductive sintered layer forming composition according to claim 1, wherein a total weight ratio of the metal particle and the silver oxide within the composition is 70 to 95%.

3. The conductive sintered layer forming composition according to claim 2, containing ink, or solvent or reducing agent for pasting.

4. The conductive sintered layer forming composition according to claim 1, wherein grain size of the metal particle is 1 to 100 nm.

5. The conductive sintered layer forming composition according to claim 1, wherein organic substance coating the surface of the metal particle contains one or more types of functional group selected from groups of carboxylic acids, alcohols and amines.

6. The conductive sintered layer forming composition according to claim 1, wherein the metal particle is a simple substance selected from a group of Au, Ag, Cu, Ni, Ti, Pt and Pd or two or more types of metal or alloy selected from the group of Au, Ag, Cu, Ni, Ti, Pt and Pd.

7. The conductive sintered layer forming composition according to claim 1, wherein grain size of the silver oxide particle is 1 nm to 50 μm.

8. The conductive sintered layer forming composition according to claim 1, wherein a composition rate of the silver oxide to the metal particle whose surface is coated with the organic substance is within a range of weight ratio larger than 0 and smaller than 400.

9. A bonding method for bonding materials to be bonded by disposing the conductive sintered layer forming composition containing both metal particles whose surface is coated with organic substance and whose grain size is 1 nm to 5 μm and silver oxide particles, between the materials to be bonded, and by heating at temperature of more than 100° C. and less than 400° C.

10. The bonding method according to claim 8, further including a pressurizing process.

11. The bonding method according to claim 9, wherein a load of the pressurization is larger than zero and smaller than 10 MPa.

12. A conductive coating film forming method for fabricating a conductive coating film by applying the conductive sintered layer forming composition containing both metal particles whose surface is coated with organic substance and whose grain size is 1 nm to 5 μm and silver oxide particles, to a substrate, and by heating it at temperature of more than 100° C. and less than 400° C.
